(19) United States
(12) Patent Application Publication
(10) Pub. No.: US 2014/0205813 A1
(43) Pub. Date: Jul. 24, 2014

(54) IMAGE PROCESSING APPARATUS AND IMAGE PROCESSING METHOD

(71) Applicant: Canon Kabushiki Kaisha, Tokyo (JP)

(72) Inventors: Makoto Torigoe, Tokyo (JP); Takeshi Yazawa, Yokohama-shi (JP); Hinako Ojiro, Wynnewood (JP); Kei Yoshizawa, Yokohama-shi (JP)

(73) Assignee: CANON KABUSHIKI KAISHA, Tokyo (JP)

(21) Appl. No.: 14/153,340

(22) Filed: Jan. 13, 2014

(30) Foreign Application Priority Data
Jan. 23, 2013 (JP) 2013-010350

(51) Int. Cl. B44F 11/02; B41J 2/525

(52) U.S. Cl. CPC B44F 11/02; B41J 2/525
USPC 428/172; 347/16; 399/38

(57) ABSTRACT

One objective of the present invention is to provide an image processing apparatus and an image processing method, whereby a difference of gloss at irregular, very small portions can be appropriately reproduced. The image processing apparatus determines, based on image data for an image to be printed on a print medium, amounts of a color printing material for printing the image on the print medium and an image quality control material for adjusting glossiness of the image, and obtains information on an unevenness level of a surface of the image based on the image data. In the above determining, the amount of the image quality control material to be applied to the print medium is determined based on the unevenness level indicated by the obtained information.

### BACKGROUND OF THE INVENTION

1. Field of the Invention

The present invention relates to an image processing apparatus and an image processing method whereby gloss of an image printed by using color materials can be controlled.

2. Description of the Related Art

In recent years, high quality printing is requested for printing apparatuses, including ink jet printers, in order to more faithfully reproduce art objects, such as photographs and paintings, and furthermore, reproducing of the textures of paintings is also requested when printing replicas of original paintings. In a case wherein replicas of paintings on canvas, such as oil paintings, are to be printed, currently, the original painting is photographed, and the obtained photograph is printed on glossy paper or coated paper with high quality by using an ink jet printer. There is a demand on the high quality printing that even small unevenness on the canvas be reproduced to provide the texture more similar to the original work.

Further, a technique has been proposed for the ink jet printers, according to which, based on a difference in glossiness, a glossy surface area and a less glossy surface area are provided for the same print medium to print an image that exhibits special effects. For example, a printed matter is provided wherein the images of characters are printed with a low gloss level in one part of the area of a photo image that is printed with a high gloss level on the entire print medium. This printed matter provides the effects that, depending on the visual angles, the characters stand out against the background, and therefore, this printing technique can be employed for, for example, decorative printing for catalogues and graphic art. A method whereby a printed matter can be applied for the above described decorative printing is disclosed in patent document 1 (Japanese Patent No. 4040417). According to this method, a colorless transparent liquid for image quality improvement is employed, and when the image quality improvement liquid is to be applied to a print medium, the number of times for scanning by a print head and thinning data thinned for the individual scans are changed to control the gloss level. When this method is employed, gloss at plurality of levels can be obtained in a printed matter with a simple configuration.

Further, an electrophotographic technique for performing decorative printing is disclosed in patent document 2 (Japanese Patent Laid-Open No. 2009-267610). According to this technique, a user employs a scanner to read a desired image that is to be formed using clear toner, and thereafter, transparent toner is applied to the object that matches the obtained image.

Generally, in a case wherein a reproduction of a painting on canvas is to be printed by employing a printing apparatus, the original painting is photographed by an imaging apparatus, such as a digital camera, and based on the obtained image data, an image is printed on a print medium by the printing apparatus. At this time, since the unique surface unevenness of the canvas is represented by brightness on the obtained photo image, the unevenness of the canvas surface is reproduced also by the brightness on an image that is printed by the printing apparatus. The brightness on the image may be represented also by the hues or densities of color inks; however, when the gloss of the print is controlled, more superior reproducibility can be obtained. For example, for the actual canvas, the raised portions of the surface unevenness are comparatively flat, and therefore, the gloss is high, while smaller unevenness is present in the recessed portions, and therefore, the gloss is low. Therefore, when a difference in the gloss can be reproduced by employing the technique disclosed in Japanese Patent No. 4040417 or Japanese Patent Laid-Open No. 2009-267610, texture provided by the rough surface of the canvas can also be reproduced.

### SUMMARY OF THE INVENTION

One objective of the present invention is to provide an image processing apparatus and an image processing method, whereby a difference in gloss among irregular, tiny portions can be appropriately reproduced.

In a first aspect of the present invention, there is provided an image processing apparatus comprising: a determining unit configured to determine, based on image data for an image to be printed on a print medium, amounts of a color printing material for printing the image on the print medium and an image quality control material for adjusting glossiness of the image; and an unevenness information obtaining unit configured to obtain information on an unevenness level of a surface of the image based on the image data; wherein the determining unit determines the amount of the image quality control material to be applied to the print medium based on the unevenness level indicated by the information obtained by the unevenness information obtaining unit.

In a second aspect of the present invention, there is provided an image processing method comprising: a determining step of determining, based on image data for an image to be printed on a print medium, amounts of a color printing material for printing the image on the print medium and an image quality control material for adjusting glossiness of the image; and an unevenness information obtaining step of obtaining information on an unevenness level of a surface of the image based on the image data; wherein in the determining step, the amount of the image quality control material to be applied to the print medium is determined based on the unevenness level indicated by the information obtained in the unevenness information obtaining step.

According to the present invention, a difference in gloss levels among tiny irregular portions can be appropriately reproduced. Therefore, texture of a work of art can be more appropriately reproduced in replica printing, and the quality of a print can be improved.

Further features of the present invention will become apparent from the following description of exemplary embodiments (with reference to the attached drawings).

### BRIEF DESCRIPTION OF THE DRAWINGS

FIGS. 1A to 1D are diagrams for explaining gloss and haze;

FIGS. 2A to 2F are diagrams for explaining a relationship, relative to gloss and image clarity, of a state wherein dots are formed on a print medium using colored inks and an image quality improvement liquid;

FIG. 3 is a diagram for explaining a relationship in FIGS. 2A to 2F of a dot formation state with respect to the image clarity and gloss;

FIG. 4 is a perspective view of the external appearance of an ink jet printing apparatus applied for a first embodiment of the present invention;

FIG. 5 is a perspective view of the internal structure of the main body of the ink jet printing apparatus;

FIG. 6 is a diagram showing the arrangement of nozzle arrays for ejecting six color inks and the arrangement of a nozzle array for ejecting a colorless transparent liquid for image quality improvement, all of which are provided for a print head for the first embodiment;

FIG. 7 is a block diagram illustrating the arrangement of the control system of the ink jet printing apparatus according to the first embodiment;

FIG. 8 is a block diagram illustrating the arrangement of the image processor of the ink jet printing apparatus according to the first embodiment;

FIG. 9 is a diagram showing an example dot pattern employed for the ink jet printing apparatus according to the first embodiment;

FIG. 10 is a diagram showing a mask pattern employed for multi-pass printing;

FIG. 11 is a diagram showing the multi-pass printing process employing the mask pattern in FIG. 10;

FIG. 12 is a diagram showing a characteristic mask pattern employed for the first embodiment;

FIGS. 13A and 13B are diagrams showing a method employing an image quality improvement liquid for decorative printing, and the effects obtained for decorative printing;

FIG. 14 is a diagram showing a mask pattern employed for decorative printing with an image quality improvement treatment liquid according to the first embodiment;

FIG. 15 is a diagram showing a method whereby the print head of the first embodiment applies, to a print medium, color inks and the image quality improvement liquid;

FIGS. 16A to 16F are diagrams for explaining the processing for forming dots of the image quality improvement liquid on a print medium in order to obtain the decorative effects for the first embodiment;

FIG. 17 is a diagram for explaining the relationship of the dot formation state in FIGS. 16A to 16F, relative to the image clarity and gloss;

FIGS. 18A and 18B are diagrams showing the state for the first embodiment wherein a mask pattern for color inks and image quality improvement liquid for gloss control and a mask pattern for the image quality improvement liquid for decorative printing are employed in the multi-pass printing process;

FIG. 19 is a schematic diagram showing the state wherein the image quality improvement liquid for gloss control and the image quality improvement liquid for decorative printing are formed on a print medium;

FIG. 20 is a diagram for explaining preparation of eight types of ink employed for the first embodiment of the present invention;

FIG. 21 is a diagram showing an example image obtained by photographing a painting on canvas;

FIG. 22 is a diagram showing an image obtained by extracting, from the Y components of the image in FIG. 21, only the high frequency components that are higher than the predetermined threshold frequency in the first embodiment of the present invention;

FIG. 23 is a flowchart showing a determination method for determining the recessed portions or the raised portions of canvas;

FIGS. 24A and 24B are diagrams showing the state, for a second embodiment of the present invention, wherein a mask pattern used for color ink and an image quality improvement liquid for gloss control and a mask pattern used for an image quality improvement liquid for decorative printing are employed for multi-pass printing; and

FIG. 25 is a schematic diagram showing the state for the second embodiment, wherein the image quality improvement liquid for gloss control and the image quality improvement liquid for decorative control are formed on a print medium.

### DESCRIPTION OF THE EMBODIMENTS

The preferred embodiments of the present invention will now be described in detail.

[Method for Evaluating Gloss and Image Clarity]

First, gloss and image clarity for the surface of a print, which are employed as references to evaluate the gloss uniformity of a printed image, will be described for the embodiments of the present invention.

The indexes employed for evaluating impression of the gloss on a print medium or a printed image are gloss and image clarity. A gloss evaluation method and a relationship between gloss and image clarity will now be described.

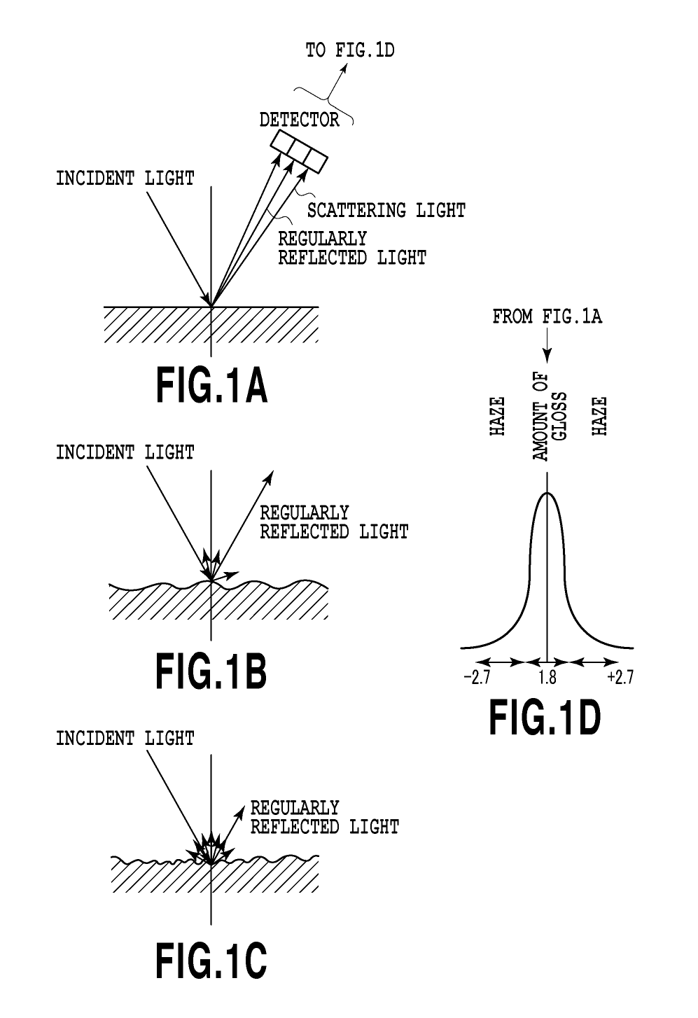

FIGS. 1A to 1D are diagrams for explaining a relationship of light reflected on the surface of a print and detected by a detector, with respect to gloss and haze.

As shown in FIG. 1A, when light reflected on the surface of a print is detected by the detector, a value of 20° specular gloss (hereinafter referred to as gloss) and a haze value can be obtained. A detector employed here is, for example, B-4632 (Japanese name: Macro-haze Plus) manufactured by BYK-Gardner Co., Ltd. The reflected light is distributed through a certain angle around the axis of regularly reflected light. As shown in FIG. 1D, the level of gloss is detected, for example, over an opening width of 1.8° around the center of the detector, and the haze is detected within the range of ±2.7° outside the gloss level.

That is, when reflected light is observed, the reflectivity with respect to incident light, of the regularly reflected light that serves as the central axis of the distribution of reflected light, is defined as the level of gloss. When the gloss level is increased, the observer visually receives greater gloss effects. Furthermore, when scattering light that occurs near the regularly reflected light is measured in the distribution of reflected light, this light is defined as haze or a haze value. When the haze value is large, a printed image is observed to be white and cloudy, regardless of high gloss. It should be noted that the unit of gloss and the unit of haze measured by the detector are dimensionless numbers, and the unit of the gloss conforms to the K5600 of the JIS standard, while the unit of the haze conforms to the DIS13803 of the ISO standard.

The image clarity is measured by employing, for example, JIS H8686, “Test methods for image clarity of anodic oxide coatings on aluminum and aluminum alloys”, or JIS K7105, “Test methods for optical properties of plastics”, and represents the clearness of an image reflected in a print medium. For example, in a case wherein an image reflected in a print medium is blurred, the value of image clarity is low. As an image clarity measurement device that conforms to the JIS standards, image clarity meter ICM-1T (manufactured by Suga Test Instruments, Co., Ltd.) and image clarity meter GP-1S (manufactured by Optec Co., Ltd.) are available on the market.

FIGS. 1B and 1C are diagrams showing the states wherein the amount of reflected light and the direction of the reflected light are changed depending on the unevenness on the surface of a printed image. As shown in FIGS. 1A to 1C, generally, when the surface unevenness is increased, the reflected light scatters and the amount of regularly reflected light is reduced, and therefore, the image clarity and the gloss level measured are reduced. Hereinafter, in the embodiments of the present invention, when a measurement value for image clarity is smaller than a target image clarity value, this is represented as low image clarity. Further, when a measurement value for gloss is smaller than a target gloss level, this is represented as low gloss.

[Relationship Between Dot Formation State and Gloss/Image Clarity]

In order to obtain uniform gloss on an image printed using pigment inks, it is required that a colorless transparent liquid for image quality improvement and the pigment inks must be mixed based on a printing duty of pigment color inks (color materials) which are color printing materials, i.e., in accordance with the density of dots.

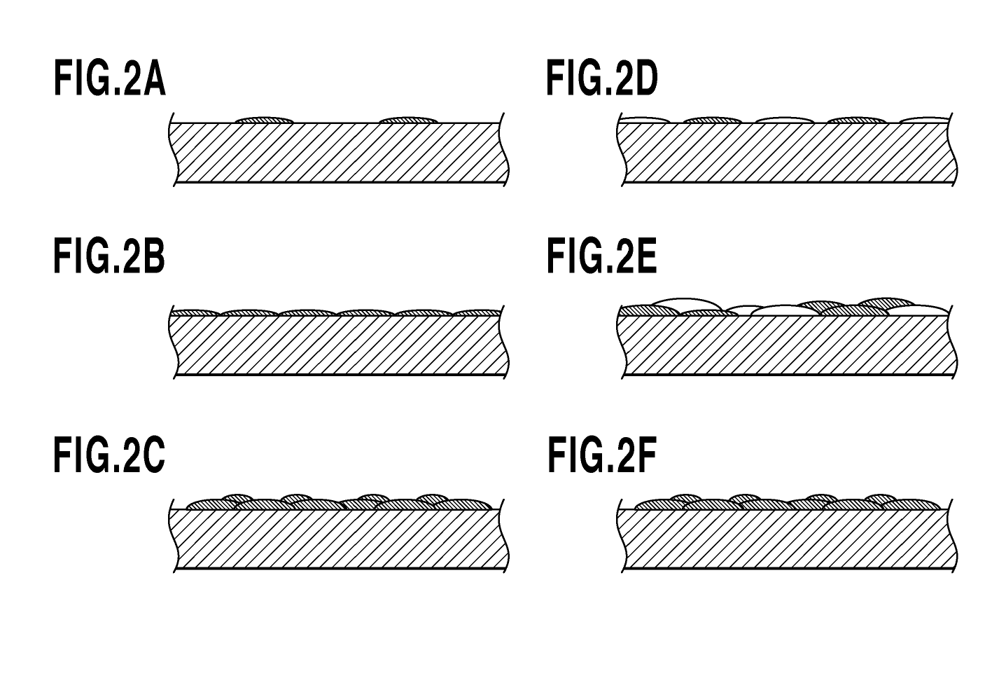

FIGS. 2A to 2F are diagrams for explaining a relationship between the states wherein dots are formed on a print medium and gloss/image clarity. In the states in FIGS. 2A to 2C, only dots of color inks are formed on the surface of the print medium in accordance with the dot density, while in the states in FIGS. 2D to 2F, an image quality improvement liquid is applied to the states in FIGS. 2A to 2C.

The dot formation state in FIG. 2A indicates a highlight portion where color ink dots are formed with a comparatively low density. At this time, the gloss of the print medium greatly contributes to the gloss level for the surface of the print (the gloss level here indicates 20° specular gloss defined by JIS; the detailed explanation for this will be given later for the first embodiment). Generally, the gloss of pigment color ink is higher than the gloss of the print medium. Therefore, as shown in FIG. 2D, the image quality improvement liquid should be applied to the area of the highlight portion where color ink dots are not formed, so that a difference in gloss should be reduced, relative to the halftone portion and a shadow portion. This technique is disclosed also in the patent document 1.

In the halftone portion shown in FIG. 2B, color ink dots are formed with a comparatively high density, i.e., color ink dots are formed, at a high rate, in the surface of the print medium. At this time, the gloss level on the entire surface of the print medium is very high because of high gloss of the pigment color ink. Especially in a case wherein ink with a low pigment concentration, so-called light ink is employed to provide the state in FIG. 2B, the state wherein 20° specular gloss exceeds 100 is obtained. This gloss is not very preferable because the surface seems too shiny for a printed matter. The present inventors conducted a test using subjects to examine the optimal 20° specular gloss, and obtained the result indicating that the subjects identified the favorable gloss level as 60 to 80.

However, since the specular gloss of the image quality improvement liquid is not very different from the specular gloss for the color ink, the gloss level can not be reduced even by applying the image quality improvement liquid to the whole color ink. Therefore, as shown in FIG. 2E, dots are formed by mixing the color ink with the image quality improvement liquid to a degree, and unevenness is provided for the surface of the printed matter (print surface). As a result, strong specular gloss can be controlled. The performance of this printing process affects image clarity (how clearly an image is reflected in a print surface), which is another element to determine the level of gloss, and the image clarity is slightly lowered. However, when a balance of the gradation relative to the other gradations is obtained, the entire gloss can be uniform.

The state in FIG. 2C represents color ink dots formed in a shadow portion. As shown in FIG. 2C, since the solids content, such as the coloring material and dispersed resin of pigment ink, is increased at the portion where color ink dots overlap each other, the surface layer is raised from the surface of the printed medium, and as a result, the unevenness occurs on the entire surface. At this time, as described above, image clarity for the print surface is slightly lowered; however, excessive increase of the specular gloss can be suppressed, and 20° specular gloss is a value in a range of about 60 to 80, which is the above described favorable value. Therefore, for the state in FIG. 2C, gloss control is not required using the image quality improvement liquid, and the state in FIG. 2F becomes the same as that in FIG. 2C.

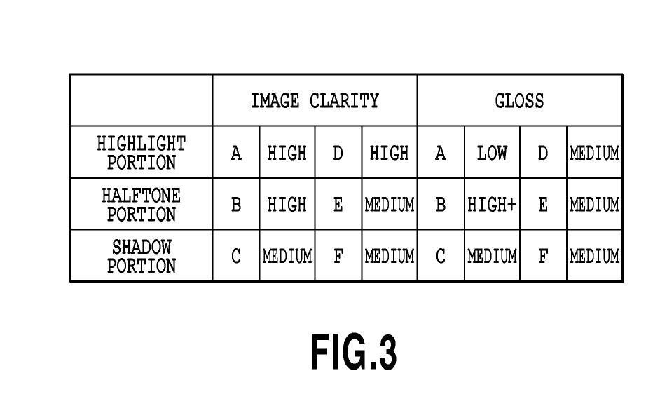

The relationship of glossiness (20° specular gloss and image clarity) for all of the states in FIGS. 2A to 2F is shown in FIG. 3. Reference sings A to F in FIG. 3 correspond to conditions shown in FIG. 2A to FIG. 2F respectively.

[Apparatus Configuration]

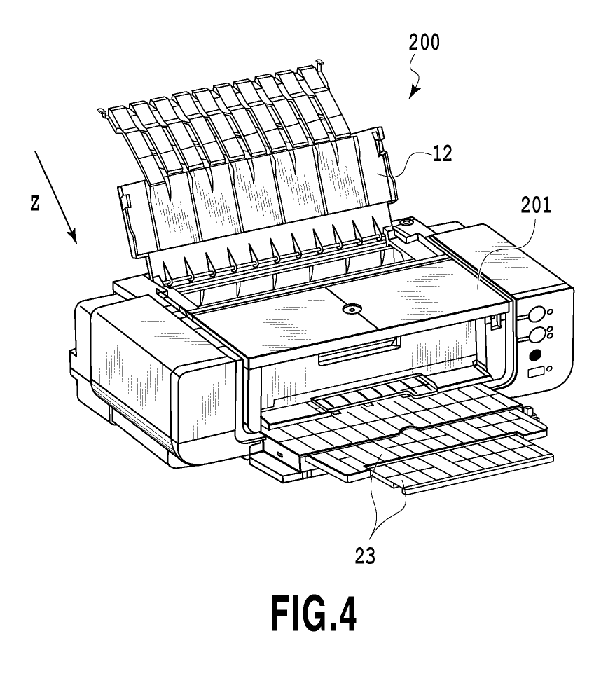

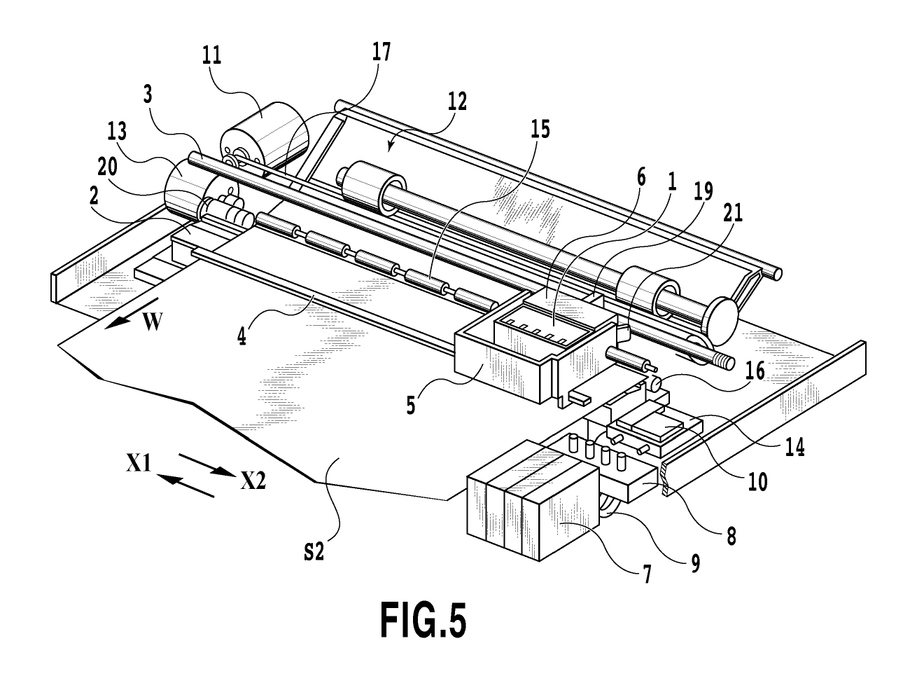

FIG. 4 is a perspective view of the external appearance of an ink jet printing apparatus 200 that is a printing apparatus applied for the embodiments of this invention, and FIG. 5 is a perspective view of the internal arrangement of a main body 201 of the ink jet printing apparatus 200.

For the ink jet printing apparatus 200 for the embodiments of this invention, printing media stacked on a supply tray 12 are fed, one sheet at a time, to the inside of a main body 201 in a direction indicated by an arrow Z in FIG. 4. Thereafter, while the print medium is conveyed intermittently in the main body 201, printing of an image is performed on the print medium, which is then discharged to a discharge tray 23. A glossy medium such as so-called glossy paper can be used for a decorative print, which will be described later.

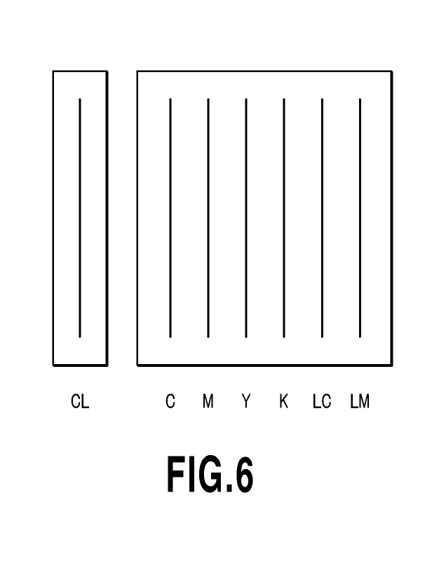

The structure of the main body 201 and the printing operation will be described more in detail. In FIG. 5, a print head 1 that is mounted on a carriage 5 and serves as a printing unit is reciprocally moved along a guide rail 4 in directions indicated by arrows X1 and X2, and ejects ink from nozzles to form images on a print medium S2. The print head 1 includes, for example, a plurality of nozzle arrays, from which different color inks are to be ejected, and a nozzle array from which an image quality improvement liquid is to be ejected. In the embodiments of this invention, multiple nozzle arrays are prepared in consonance with ink of six colors, cyan (C), magenta (M), yellow (Y), black (K), light cyan (LC) and light magenta (LM). In the embodiments of the invention, a nozzle array for ejecting a colorless transparent liquid (CL) for image quality improvement is also prepared. These color inks and the image quality improvement liquid are stored in the individual ink tanks (not shown), and are supplied from the ink tanks to the corresponding nozzle arrays of the print head 1. The arrangement of the nozzle arrays for ejecting six color inks and the arrangement of the nozzle array for ejecting the colorless transparent liquid for image quality improvement are shown in FIG. 6.

For the embodiments of this invention, the ink tanks (not shown) and the print head 1 constitute a head cartridge 6, which is mounted on the carriage 5. Further, when the drive force of a carriage motor 11 is transmitted to the carriage 5 by a timing belt 17, the carriage 5 is reciprocally moved along a guide shaft 3 and the guide rail 4 in the directions indicated by the arrows X1 and X2 (main scanning direction). The location of the carriage 5 is detected when an encoder sensor 21 mounted to the carriage 5 reads a linear scale 19 provided in the direction in which the carriage 5 moves.

When the print medium S2 to be printed has been fed from the supply tray 12 to the main body 201, the print medium S2 is conveyed to a platen 2 by a conveying roller 16 and pinch rollers 15. Thereafter, the carriage 5 is moved in the direction X1, while the print head 1 ejects ink to perform printing for one scanning, and thereafter, the conveying roller 16 is rotated via a linear wheel 20 by the drive force of a conveying motor 13. As a result, the print medium S2 is conveyed at a predetermined distance in a direction indicated by an arrow W that is the sub-scanning direction. Then, the carriage 5 is moved in the direction X2, and at the same time, printing for the next scanning is performed for the print medium S2. As shown in FIG. 5, a head cap 10 and a recovery unit 14 are arranged at the home position along the traveling pass of the carriage 5, and the recovery process for the print head 1 is intermittently performed, as needed. When the above described processing is repeated to complete printing for the print medium S2, the print medium S2 is discharged, and printing for one sheet is completed in this manner.

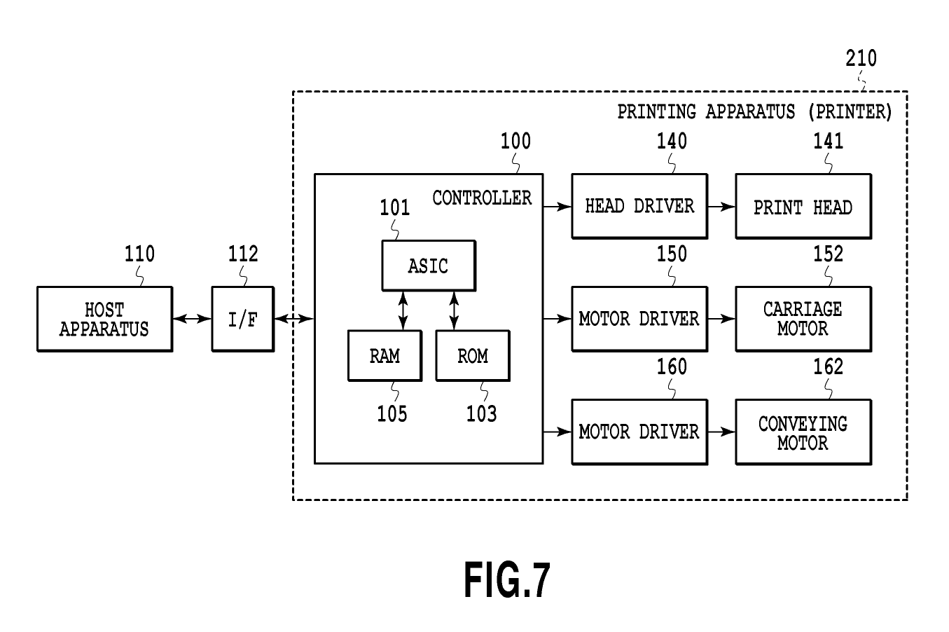

FIG. 7 is a block diagram illustrating the control system of an ink jet printing apparatus (hereinafter simply referred to as a printing apparatus) for the embodiments of this invention. A controller 100 is included in a main body 210 of a printing apparatus. The controller 100 is a main control unit that controls the individual sections of the printing apparatus, and includes, for example, an ASIC 101, a ROM 103 and a RAM 105 in the form of a microcomputer. A dot arrangement pattern, a mask pattern and other fixed data are stored in the ROM 103, while an area for expanding image data and a work area are included in the RAM 105. The ASIC 101 performs the processing beginning with reading of a program from the ROM 103 until printing of image data on a print medium.

A host apparatus 110 is a source that supplies image data that will be described later (may be a computer that creates or processes image data to be printed, or may be a reader for scanning images). Image data, other commands and status signals are transmitted to, or received from the controller 100 via an interface (I/F) 112. The host apparatus may be provided in the printing apparatus or an external PC may be used as the host apparatus.

A head driver 140 is a driver that drives the print head 1 in accordance with, for example, print data. A motor driver 150 is a driver that drives a carriage motor 11, and a motor driver 160 is a driver that drives the conveying motor 13.

[Ink Composition]

Next, color inks that contain pigment materials (hereinafter also referred simply as inks) and a colorless and transparent, image quality improvement liquid that is employed for gloss control, all of which are employed by the ink jet printing apparatus of the embodiments, will be described.

First, the individual components of ink will be described.

(Aqueous Medium)

It is preferable that ink used for this invention be an aqueous medium that contains water and a water-soluble organic solvent. The content (mass %) of the water-soluble organic solvent in ink is preferably 3.0 mass % or more to 50.0 mass % or less with the total mass of ink as a reference. Further, it is also preferable that the content (mass %) of water in ink be 50.0 mass % or more to 95.0 mass % or less with the total mass of ink as a reference.

The typical water-soluble organic solvents can be the following examples.
Alkyl alcohols having 1 to 6 carbon atoms, such as methanol, ethanol, propanol, propanediol, butanol, butanediol, pentanol, pentanediol, hexanol and hexanediol
Amides, such as dimethylformamide and dymethylacetamide
Ketones or ketoalcohols, such as acetone or diaceton alcohol
Ethers, such as tetrahydrofuran and dioxane
Polyalkylene glycols with a mean molecular weight of 200, 300, 400, 600 or 1,000, such as polyethylene glycol and polypropylene glycol
Alkylene glycols with an alkylene group having 2 to 6 carbon atoms, such as ethylene glycol, propylene glycol, butylene glycol, triethylene glycol, 1,2,6-hexanetriol, thiodiglycol, hexylene glycol and diethylene glycol
Lower alkyl ether acetate, such as polyethylene glycol monomethyl ether acetate
Glycerine
Lower alkyl ethers of polyhydric alcohols, such as ethylene glycol monomethyl (or monoethyl)ether, diethylene glycol monomethyl (or monoethyl)ether and triethylene glycol monomethyl (or monoethyl)ether
N-methyl-2-pyrrolidone, 2-pyrrolidone, 1,3-dimethyl-2-imidazolidinone, etc.

Further, it is preferable that deionized water (ion-exchanged water) be employed.

(Pigment)

Carbon black or an organic pigment is preferably employed. It is also preferable that the content (mass %) of a pigment in ink be 0.1 mass % or more to 15.0 mass % or less with the total mass of ink as a reference.

For black ink, carbon black, such as furnace black, lamp black, acetylene black or channel black, is employed as a preferable pigment. Specifically, the following goods on the market, for example, can be employed.
Raven 7000, 5750, 5250, 5000 ULTRA, 3500, 2000, 1500, 1250, 1200, 1190 ULTRA-II, 1170 and 1255 (produced by Columbian Chemicals Company)
Black Pearls L, Regal 330R, 400R and 660R, Mogul L, Monarch 700, 800, 880, 900, 1000, 1100, 1300, 1400 and 2000, and Vulcan XC-72R (produced by Cabot Corporation)
Color black FW1, FW2, FW2V, FW18, FW200, S150, S160 and S170, Printex 35, U, V, 140U and 140V, and Special Black 6, 5, 4A and 4 (produced by Evonic industries)
No. 25, No. 33, No. 40, No. 47, No. 52, No. 900, No. 2300, MCF-88, MA600, MA7, MA8 and MX100 (produced by Mitsubishi Chemical Corporation)

Further, new carbon black prepared for the embodiments of this invention can also be employed. The present invention is not limited to these materials, and any types of conventional carbon black can also be employed. Furthermore, the material is not limited to carbon black, and magnetic particles, such as magnetite or ferrite, or titanium black may also be employed as a pigment.

The following materials, for example, can be employed as organic pigments.
Insoluble azo pigments, such as toluidine red, toluidine maroon, hanza yellow, benzidine yellow and pyrazolone red
Soluble azo pigments, such as lithol red, helio Bordeaux, pigment scarlet and permanent red 2B; derivatives of vat dyes, such as alizarin, indanthrone and thioindigo maroon; and phthalocyanine pigments, such as phthalocyanine blue and phthalocyanine green
Quinacridone pigments, such as quinacridone red and quinacridone magenta
Perylene pigments, such as perylene red and perylene scarlet
Isoindolinone pigments, such as isoindolinone yellow and isoindolinone orange
Imidazolone pigments, such as benzimidazolone yellow, benzimidazolone orange and benzimidazolone red
Pyranthrone pigments, such as pyranthrone red and pyranthrone orange
Indio-based pigments, condensed azo pigments, thioindigo pigments and diketopyrropyrrole pigments; flavanthrone yellow, acylamido yellow, quinophthalone yellow, nickel azo yellow, copper azomethine yellow, perinone orange, anthrone orange, dianthraquinonyl red, dioxazine violet, etc.

It should be noted that the pigments for the present invention are not limited to those.

When the organic pigments are represented by color index (C.I.) numbers, the following pigments can be employed, for example.
C.I. Pigment Yellow: 12, 13, 14, 17, 20, 24, 74, 83, 86, 93, 97, 109, 110, 117, 120, 125, 128, 137, 138, 147, 148, 150, 151, 153, 154, 166, 168, 180, 185, etc.
C.I. Pigment Orange: 16, 36, 43, 51, 55, 59, 61, 71, etc.
C. I. Pigment Red: 9, 48, 49, 52, 53, 57, 97, 122, 123, 149, 168, 175, 176, 177, 180, 192, etc.
C. I. Pigment Red: 215, 216, 217, 220, 223, 224, 226, 227, 228, 238, 240, 254, 255, 272, etc.
C. I. Pigment Violet: 19, 23, 29, 30, 37, 40, 50, etc.

C. I. Pigment Blue: 15, 15:1, 15:3, 15:4, 15:6, 22, 60, 64, etc.
C. I. Pigment Green: 7, 36, etc.

C. I. Pigment Brown: 23, 25, 26, etc.

It should be noted that the pigments for the present invention are not limited to those.

(Dispersant)

An arbitrary dispersant that is a water-soluble resin can be employed to disperse the above described pigments in an aqueous medium. A dispersant that has a weight-average molecular weight of 1,000 or greater to 30,000 or smaller is preferable, and a dispersant that has a weight-average molecular weight of 3,000 or greater to 15,000 or smaller is especially preferable. It is preferable that the content (mass %) of the dispersant in ink be 0.1 mass % or greater to 5.0 mass % or smaller with the total mass of ink as a reference.

Specifically, the following dispersants, for example, can be employed: styrene, vinylnaphthalene, α,β-ethylenic unsaturated carboxylic acid aliphatic alcohol ester, acrylic acid, maleic acid, itaconic acid, fumaric acid, vinyl acetate, vinylpyrrolidone, acrylamide, and a polymer produced by using derivatives of these compounds as monomers. Further, it is preferable that one or more monomers of the polymer be hydrophilic monomers, and a block copolymer, a random copolymer, a graft copolymer, or sodium salt of one of these copolymers may be employed. Furthermore, natural resins, such as rosin, shellac and starch, may also be employed. Preferably, these resins are soluble in a solution where a base is dissolved, i.e., are alkali soluble.

(Surfactant)

It is preferable that a surfactant, such as an anionic surfactant, a nonionic surfactant or an amphoteric surfactant, be employed to adjust the surface tension of ink that belongs to an ink set. Specifically, polyoxyethylene alkylether, polyoxyethylene alkylphenols, acetylenic glycol compounds or ethylene oxide adducts of acetylene glycol, for example, can be employed.

(Other Components)

The ink that belongs to the ink set may also contain, in addition to the above described components, the water-retention solids content, such as urea, a urea derivative, trimethylolpropane or trimethylolethane, in order to maintain moisture. The content (mass %) of the water-retention solids content in ink is preferably 0.1 mass % or more to 20.0 mass % or less, and more preferably, 3.0 mass % or more to 10.0 mass % or less with the total mass of ink as a reference. Further, in addition the above described components, the ink for the ink set may contain, as needed, various types of additives, such as a pH control agent, a corrosion inhibitor, an antiseptic, an anti-mold agent, an antioxidant, an anti-reduction agent and an evaporation accelerating agent.

Next, ink employed for the embodiments will be more specifically described. The present invention is not limited to the embodiments described below so long as ink employed does not depart from the subject of the invention. It should be noted that “part” and “%” are represented on a mass standard when especially not designated.

[Preparation of Pigment Dispersion Liquids 1 to 4]

Pigment dispersion liquids 1 to 4 were prepared by performing the following procedures. In the description below, a dispersant is an aqueous solution produced by neutralizing, with an aqueous solution of 10 mass % sodium hydroxide, a styrene/acrylic acid copolymer having an acid value of 200 and a weight-average molecular weight of 10,000.

(Preparation of Pigment Dispersion Liquid 1 Containing C. I. Pigment Red 122)

10 parts by mass of a pigment (C. I. Pigment Red 122), 20 parts by mass of a dispersant and 70 parts by mass of ionized water were mixed together, and the obtained mixture was dispersed for three hours by employing a batch type vertical sand mill. Thereafter, coarse particles were removed by performing centrifugation. Further, the resultant mixture was filtered under pressure by a Cellulose Acetate Membranes Filter (produced by Advantech Co., Ltd.) having a pore size of 3.0 μm, and a pigment dispersion liquid 1 with a pigment concentration of 10 mass % was obtained.

(Preparation of Pigment Dispersion Liquid 2 Containing C. I. Pigment Blue 15:3)

10 parts by mass of a pigment (C. I. Pigment Blue 15:3), 20 parts by mass of a dispersant and 70 parts by mass of ionized water were mixed together, and the obtained mixture was dispersed for five hours by employing a batch type vertical sand mill. Thereafter, coarse particles were removed by performing centrifugation. Further, the resultant mixture was filtered under pressure by a Cellulose Acetate Membranes Filter (produced by Advantech Co., Ltd.) having a pore size of 3.0 μm, and a pigment dispersion liquid 2 with a pigment concentration of 10 mass % was obtained.

(Preparation of Pigment Dispersion Liquid 3 Containing C. I. Pigment Yellow 74)

10 parts by mass of a pigment (C. I. Pigment Yellow 74), 20 parts by mass of a dispersant and 70 parts by mass of ionized water were mixed together, and the obtained mixture was dispersed for one hour by employing a batch type vertical sand mill. Thereafter, coarse particles were removed by performing centrifugation. Further, the resultant mixture was filtered under pressure by a Cellulose Acetate Membranes Filter (produced by Advantech Co., Ltd.) having a pore size of 3.0 μm, and a pigment dispersion liquid 3 with a pigment concentration of 10 mass % was obtained.

(Preparation of Pigment Dispersion Liquid 4 Containing C. I. Pigment Black 7)

10 parts by mass of a carbon black pigment (C. I. Pigment Black 7), 20 parts by mass of a dispersant and 70 parts by mass of ionized water were mixed together, and the obtained mixture was dispersed for three hours by employing a batch type vertical sand mill. It should be noted that the peripheral velocity for dispersion was set at twice the velocity for preparation of the pigment dispersion liquid 1. Thereafter, coarse particles were removed by performing centrifugation. Further, the resultant mixture was filtered under pressure by a Cellulose Acetate Membranes Filter (produced by Advantech Co., Ltd.) having a pore size of 3.0 μm, and a pigment dispersion liquid 4 with a pigment concentration of 10 mass % was obtained.

(Preparation of Ink)

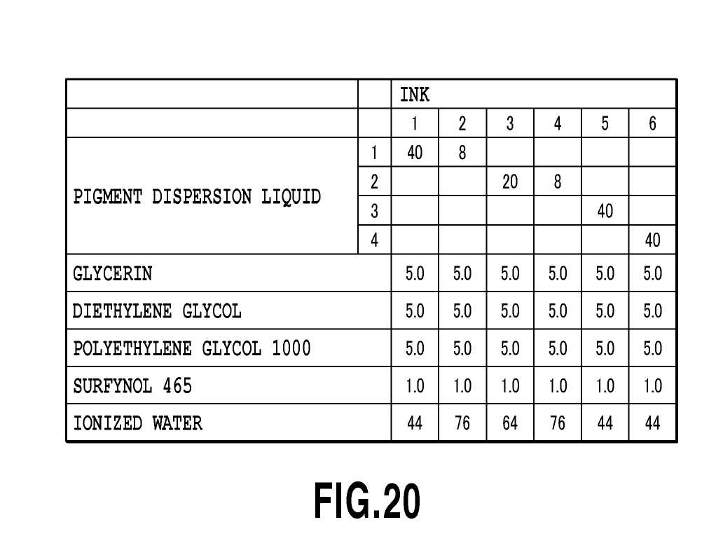

The individual components shown in FIG. 20 were mixed, and the obtained mixture was appropriately agitated. Thereafter, the mixture was filtered under pressure by a Cellulose Acetate Membranes Filter (produced by Advantech Co., Ltd.) having a pore size of 0.8 μm, and inks 1 to 6 were prepared.

Next, a colorless, transparent, image quality improvement liquid that is employed for gloss control in the embodiments will be described.

[Preparation of Image Quality Improvement Liquid]

A styrene (St)/acrylic acid (AA) copolymer X (St/AA=70/30 (mass %), molecular weight: 10,500, and measured acid value: 203) was produced by a solution polymerization method using a radial initiator, and was employed to prepare a liquid composition A below. In this case, potassium hydroxide was employed as a basic substance, and the amount to be added was adjusted to obtain pH 8.0 of the liquid composition.

| | |
|---|---|
| styrene/acrylic acid copolymer X | 2 parts |
| glycerin | 7 parts |
| diethylene glycol | 5 parts |
| water | 86 parts |

The image quality improvement liquid thus obtained is a liquid used to control gloss. So long as the same effects are obtained, the composition of the image quality improvement liquid is not limited to the above described example.

### First Embodiment

The first embodiment for the printing apparatus of the present invention will now be described in detail by employing an ink jet printing apparatus as an example, while referring to the drawings.

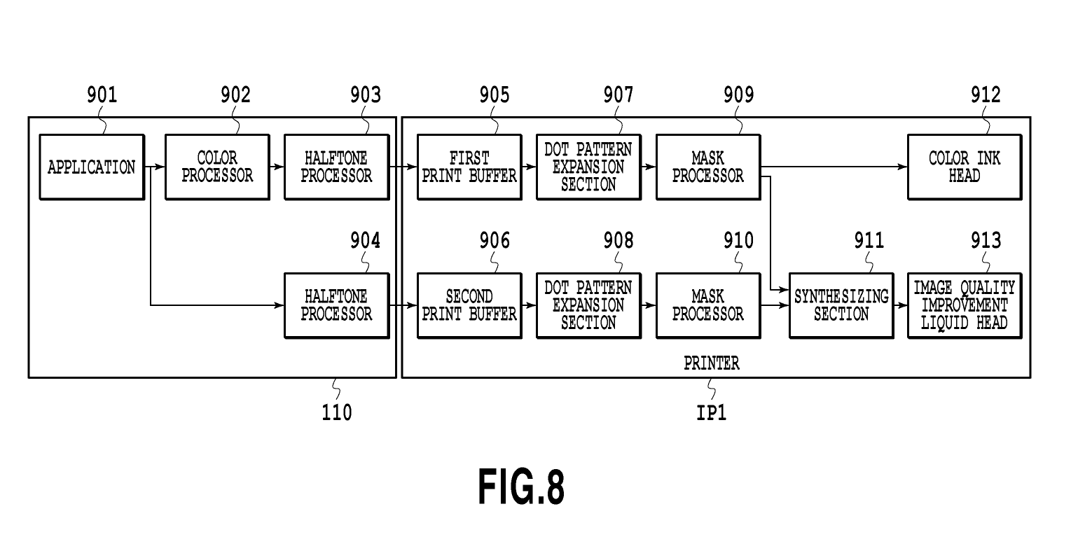

FIG. 8 is a block diagram illustrating the arrangement of the image processing part of an ink jet printing apparatus according to this embodiment.

First, an explanation will be given for the flow of the processing (first distribution data processing) for generating image data in order to apply, to a print medium, color ink and a colorless and transparent image quality improvement liquid for gloss control. In a PC 110 in FIG. 8 that is a host apparatus, image signals of 8 bits each (a signal of 24 bits in total) that correspond to the individual colors R, G and B (red, green and blue) are output as digital image data (first distribution data) by an application 901. The RGB image data is transmitted to a color processor 902. The color processor 902 converts the RGB image data into signals of cyan, magenta, yellow, black, light cyan and light magenta (hereinafter referred to simply as C, M, Y, K, LC and LM, respectively), which represent the colors of ink employed by the ink jet printing apparatus. Further, the color processor 902 converts the RGB image data into data used for a colorless and transparent image quality improvement liquid CL for gloss control. These output signals are 12 bits each for the individual colors, and a signal of 84 bits in total is produced to obtain the gradation.

A halftone processor 903 performs the pseudo continuous tone processing (halftoning processing), such as error diffusion, for a received multi-level signal of 12 bits for each color (=4096), so that the multi-level signal is converted into N-value data that is smaller than 4096. In this case, an N value is a value of about 3 to 16, having 2 to 4 bits for the individual colors. In the description for this embodiment, the multi-level halftoning is employed; however, the processing is not limited to this, and the binary halftoning process may also be employed.

In this embodiment, the processing beginning with the application 901 and ending with the halftoning processor 903 in FIG. 8 is performed by the PC (host apparatus) 110. The processing after the halftoning process is performed by the main body of the printing apparatus. Therefore, the N value data obtained by the PC through the halftoning process is stored in a first print buffer 905.

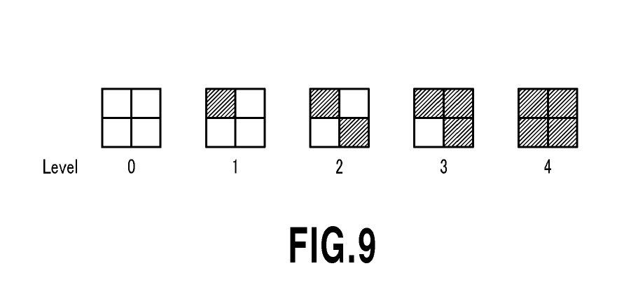

A dot pattern expansion section 907 expands dot patterns for N kinds of gradations in consonance with the N value data that is output from the first print buffer 905. An example dot pattern is shown in FIG. 9. In the example in FIG. 9, input five-valued data is expanded to a dot pattern of 2×2 pixels. In FIG. 9, hatched portions represent pixels where dots are to be formed (hereinafter, these pixels are referred to as print pixels), and blank portions represent pixels where dots are not to be formed (hereinafter, these pixels are referred to as non-print pixels).

A mask processor 909 performs a mask process for thinning image data and dividing the image data into a plurality of sets of image data. That is, for multi-pass printing where the print head is moved multiple times relative to the same image forming area to complete printing of an image, a predetermined thinning mask pattern is employed, and image data used for the same image formation is divided into image data sets in consonance with the number of times of scan.

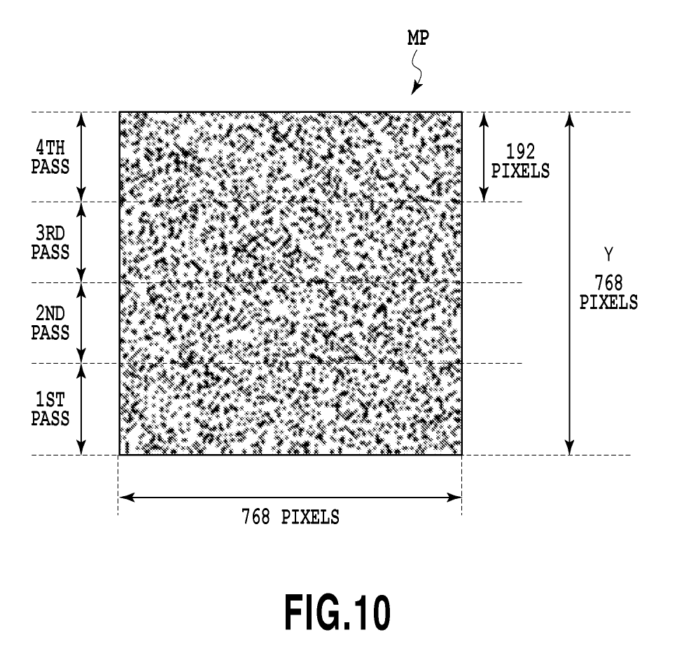

A general thinning mask pattern (hereinafter referred to simply as a mask pattern) will now be described while referring to FIG. 10. An example mask pattern shown in FIG. 10 is a mask pattern MP for four passes, with which the print head is moved for the same image formation area by four times to complete printing of an image. In this mask pattern MP, pixels where dots are to be formed by the individual scans (or also called passes) are represented by black dots, and pixels where dots are not to be formed are represented by white portions. According to the mask pattern MP, pixels for which dots are to be formed are arranged at random.

The image formation area of vertical 768 pixels×horizontal 768 pixels is to be printed by one movement of the print head. In FIG. 10, the vertical direction (direction W) indicates the direction along the nozzle arrays of the print head, and the horizontal direction (direction X) indicates the main scanning direction in which the print head moves. 768 pixels along the vertical side correspond to the number of nozzles (768 nozzles) of the print head. As indicated by broken lines in FIG. 10, when 768 pixels vertically arranged are divided into four sections of 192 pixels each, mask patterns of 1st pass to 4th pass are obtained, and are interpolated with each other. In this embodiment, substantially the same print dot formation ratio (printing duty) is provided for the individual mask patterns for 1st pass to 4th pass. The printing duty represents a ratio of the number of pixels, designated in a predetermined printing area of a print medium, relative to the number of dots to be printed in the printing area. Therefore, in a case wherein one dot is formed for all of the pixels, i.e., in a case wherein the number of pixels is equal to the number of dots, a 100% printing rate (printing duty) is established. In this embodiment, since almost the same printing ratio is provided for the mask patterns that corresponds to the individual passes, the individual mask patterns have a printing duty of about 25%.

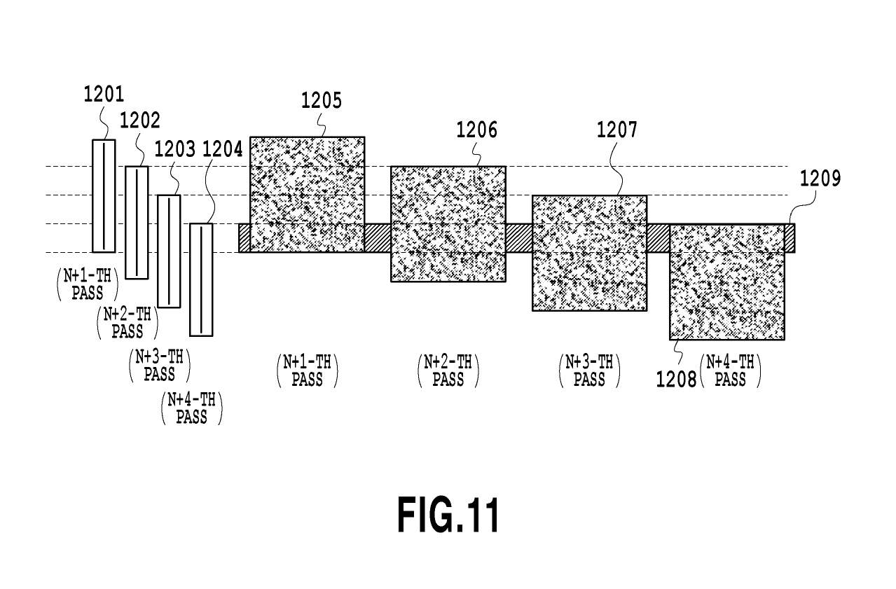

FIG. 11 is a diagram showing the multi-pass printing process employing the mask pattern in FIG. 10. In the state in FIG. 11, the same print head is denoted by 1201 to 1204, and the location of the print head and the location of the print medium are changed relative to each other each time scanning is performed. For simplification of the drawing, a print head for only one color is shown in FIG. 11. For 4-pass printing, the print medium is intermittently conveyed by a conveying mechanism (not shown) in the direction W at each distance that is equal to ¼ of the length of the nozzle array of the print head (a distance that corresponds to the length of 192 pixels), and thus, the location of the print medium relative to the print head is changed.

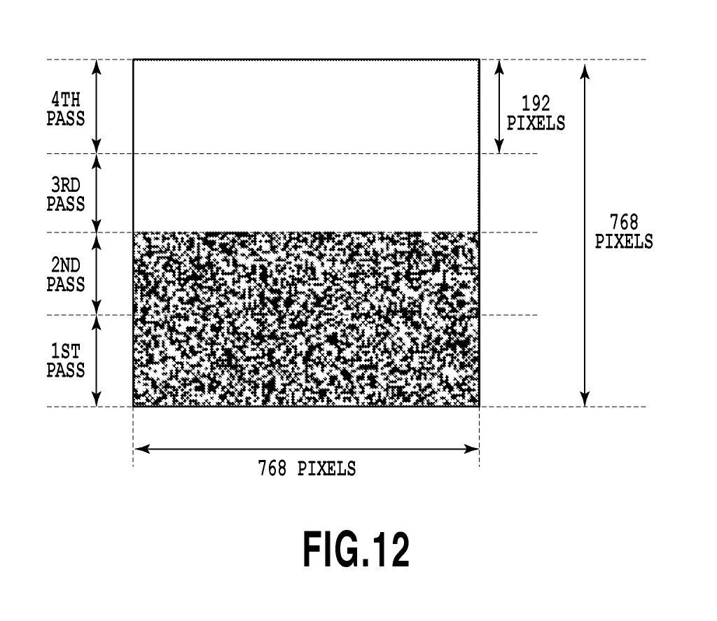

A characteristic mask pattern employed for this embodiment will now be described by employing FIG. 12. A difference from the general 4-pass mask pattern in FIG. 10 is that print dots are present only in portions that correspond to the first pass and the second pass, and no print dots are present in the areas for the third and fourth passes. That is, substantially, 2-pass printing is performed to print an image, and a printing duty for the areas for the first and second passes is about 50%. This mask pattern where print dots are present only in portions that correspond to the first and second passes is employed for printing in seven colors of ink, which are color inks C, M, Y, K, LC and LM and an image quality improvement liquid CL. As previously described in [Relationship between dot formation state and gloss/image clarity], color ink and the image quality improvement liquid should be applied through the same scanning in order to obtain uniform gloss across the area of all the gradations. That is, in order to obtain uniformity of gloss on the entire image, the type of mask pattern shown in FIG. 12 should be employed both for data used for applying color ink and for data used for applying the image quality improvement liquid.

For the color ink, the mask processor 909 in FIG. 8 performs the thinning process for image data, and thereafter, transmits to a color ink print head 912 the image data (thinned image data) obtained after the thinning, and then, the print head is driven based on the data. The color processor 902, the halftoning processor 903, the first print buffer 905, the dot pattern expansion section 907 and the mask processor 909 constitute a first distribution data generation section.

Next, an explanation will be given for the processing (second distribution data generation processing) for generating image data (second distribution data) in order to apply an image quality improvement liquid to a print medium to provide the decorative effects for an image.

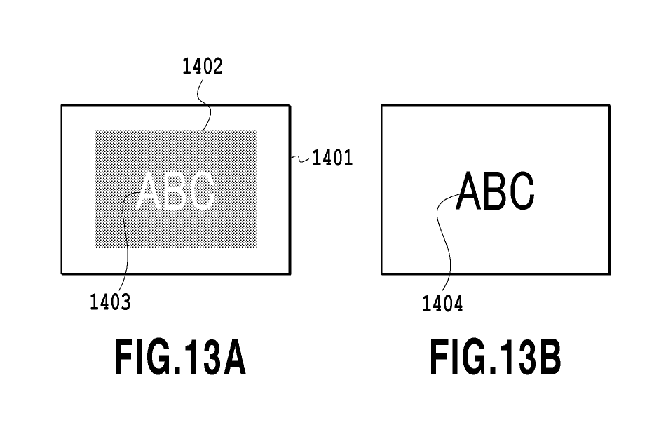

Referring to FIG. 13A, color ink is applied to an image area 1402 of a print medium 1401. Further, letters “ABC” 1403 represent letters that are decoratively printed with the image quality improvement liquid in the image area that has been printed by using color ink. When the image quality improvement liquid is applied to the portion printed in the color ink in this manner, the gloss level is changed, and the effects that the letters stand out against the background can be obtained.

While referring to FIG. 8, an explanation will now be given for the processing for generating image data that is employed by the print head to eject the image quality improvement liquid CL as decorative ink to a print medium. The application 901 generates image data 1403 shown in FIG. 13B, based on which the image quality improvement liquid CL is to be ejected to provide a decorative print 1403 shown in FIG. 13A, for example. The image data 1404 is multi-level data that is generated by employing the function of the application 901 only for the purpose of applying the image quality improvement liquid CL, and is provided separately from the common image data employed for ejection of colored ink. The image data for color ink output by the color processor 902 and the image data for the image quality improvement liquid, which is employed for gloss control in order to obtain gloss uniformity, have the size of 12 bits by taking the gradation into account. However, actually, the gradation performance is not much required for the image data used for the image quality improvement liquid for decorative printing. Therefore, the image data used for the image quality improvement liquid for decorative printing is defined as data of 8 bits, i.e., data that represents 256 gradations. The halftoning processor 904 performs the halftoning process and converts, into M-value data that is smaller than 256-value data, the received multi-level data for the image quality improvement liquid for decorative printing.

The M-value data output by the halftoning processor 904 is transmitted to a second print buffer 906 in the main body 201 of the apparatus, and is expanded by the dot pattern expansion section 908. Since this process is the same as the data processing performed for the colored ink and the image quality improvement liquid for gloss control, no detailed explanation will be given.

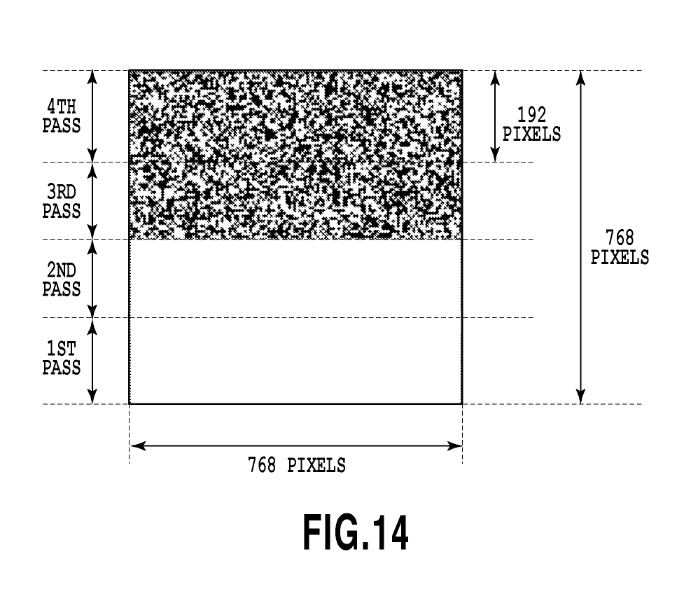

After the image data has been expanded by the dot pattern expansion section 908, the mask processor 910 performs the mask process (thinning process) for the image data. A mask pattern employed for the image quality improvement liquid for decorative printing will now be described by employing FIG. 14. The mask pattern in FIG. 14 is the vertical inversion of the mask pattern (see FIG. 12) employed for the color ink and the image quality improvement liquid for gloss control. In this mask pattern, print dots are present only in the portions corresponding to the third and fourth passes, and no print dots are present in the areas corresponding to the first and second passes.

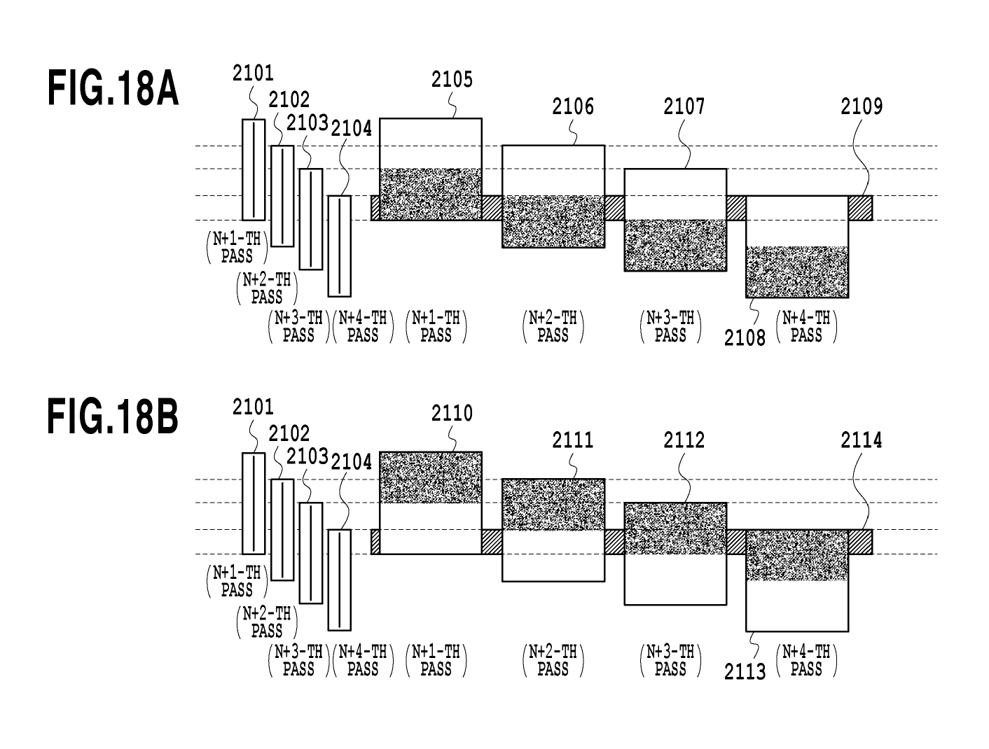

While referring to FIGS. 18A and 18B, an explanation will now be given respectively for the state wherein the color ink mask pattern in FIG. 12 is employed by the mask processor 909 during multi-pass printing, and the state wherein the decorative printing mask pattern in FIG. 14 is employed by the mask processor 910 during the multi-pass printing.

In the states in FIGS. 18A and 18B, the same print head is denoted by 1201 to 1204, and the location of the print head and the location of the print medium are changed relative to each other each time scanning is performed. For simplification of the drawings, a print head for only one color is shown in FIGS. 18A and 18B.

As shown in FIGS. 18A and 18B, for 4-pass printing, the print medium is intermittently conveyed by a conveying mechanism (not shown) in the direction W at each distance that is equal to ¼ of the length of the nozzle array of the print head, and thus, the location of the print medium relative to the print head is changed. In this case, the multi-pass printing using the color ink printing mask pattern in FIG. 12 is shown in FIG. 18A, while the multi-pass printing using the decorative printing mask pattern in FIG. 14 is shown in FIG. 18B. As shown in FIG. 18A, image formation is performed along the first two passes, i.e., a N+1-th pass and a N+2-th pass, and as shown in FIG. 18B, image formation (application of the image quality improvement liquid) is performed along the second two passes, i.e., a N+3-th pass and a N+4-th pass.

A synthesizing section 911 synthesizes the image data for gloss control that has been thinned by the mask processor 909 with the image data for decorative printing that has been thinned by the mask processor 910. As shown in FIGS. 12 and 14, in the mask patterns used for thinning, mutually exclusive data are provided for the pass areas where non-print dots are present. Therefore, the synthesizing section 911 performs the logical sum processing (OR processing) for the bit data of the individual image data. The image data obtained by the synthesizing section 911 is transmitted to the print head 913 for an image quality improvement liquid, and then the print head 913 is driven based on the image data. It should be noted that the halftoning processor 904, the second print buffer 906, the dot pattern expansion section 908 and the mask processor 910 constitute a second distribution data generation section.

Next, an explanation will be given for the processing for actually applying the color ink and the image quality improvement liquid to a print medium based on the image data that has been generated through the above described data processing shown in FIG. 8.

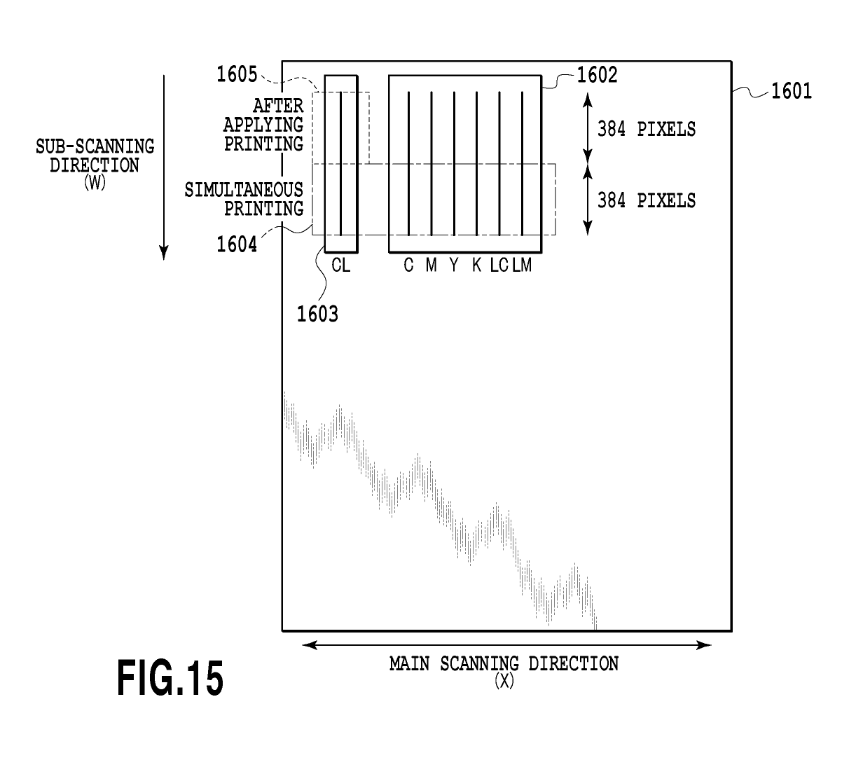

Referring to FIG. 15, reference numeral 1601 denotes a print medium, 1602 denotes a print head for color ink, and 1603 denotes a print head for an image quality improvement liquid. As shown in FIG. 15, the print heads 1602 and 1603 are arranged in the main scanning direction (in a direction indicated by an arrow X) in which the print heads 1602 and 1603 reciprocally move. Further, an area 1604 represents an area where the print head 1602 ejects color ink and also an area where the print head 1603 ejects the image quality improvement liquid for gloss control. The color ink and the image quality improvement liquid are ejected at the same time (same scan) to the print medium from the nozzles of the two print heads 1602 and 1603 that are located within the area 1604, i.e., the simultaneous printing is performed, and as a result, an image is formed.

Furthermore, in FIG. 15, an area 1605 represents an area where the print head ejects the image quality improvement liquid for decorative printing. In this area 1605, after applying printing is performed, i.e., the image quality improvement liquid is applied later to an image that has been formed in the area 1604 used by the print head 1602 that ejects color ink.

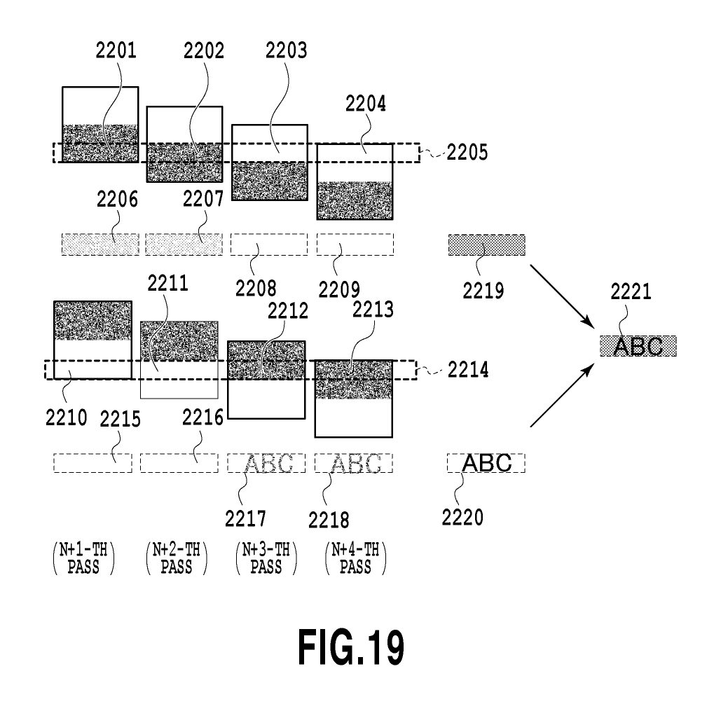

The operation for the simultaneous printing and the after applying printing described above will now be described based on a schematic diagram in FIG. 19.

First, the simultaneous printing processing where color ink and the image quality improvement liquid are applied at the same time will be described. In FIG. 19, along the N+1-th printing pass, image data used for applying color ink and the image quality improvement liquid for gloss control are thinned by employing a mask pattern 2201 of 50% duty, and the resultant image data is employed to form a thinned image 2206. Thereafter, along the N+2-th printing pass, the image data for the color ink and for the image quality improvement liquid for gloss control are thinned by using the mask pattern 2202 of 50% printing duty, and the thinned image data is employed to form a thinned image 2207. Since the mask pattern 2201 and the mask pattern 2202 are complementary to each other, the thinned images 2206 and 2207 produced based on the two mask patterns are also complementary.

The printing is performed along a N+2-th printing pass, and then along a N+3-th printing pass and along a N+4-th printing pass in the named order. Along these printing passes, the image data for the color ink and for the image quality improvement liquid for gloss control are thinned by using mask patterns 2203 and 2204 of 0% printing duty (100% thinning duty). Therefore, as indicated in areas 2208 and 2209, the color ink and the image quality improvement liquid are not applied at all to the print medium. As a result, in a print area 2205 of the print medium, an image 2219 is obtained by superimposing images 2206, 2207, 2208 and 2209, i.e., by superimposing the thinned images 2206 and 2207.

During the printing along the N+1-th printing pass to the N+4-th printing pass, the flowing process is performed to apply the image quality improvement liquid to the print medium. First, along the N+1-th printing pass and the N+2-th printing pass, the image data used to apply the image quality improvement liquid for decorative printing is thinned by using the mask patterns 2210 and 2211 of 0% printing duty (100% thinning duty). As a result, the image quality improvement liquid for decorative printing is not applied at all to the print medium, as indicated in areas 2215 and 2216.

Subsequently, along the N+3-th printing pass and the N+4-th printing pass, the image data used for applying the image quality improvement liquid for decorative printing is thinned by using the mask patterns 2212 and 2213 of 50% printing duty (50% thinning duty). As a result, images 2217 and 2218 that have been thinned by 50% are printed along the N+3-th printing pass and the N+4-th printing pass. Therefore, in a printing area 2214 of the print medium, an image 2220 is formed by superimposing the images 2215, 2216, 2217 and 2218, i.e., by superimposing the thinned images 2217 and 2218. Furthermore, since the image data for images 2219 and 2220 are synthesized by the synthesizing section 911 in FIG. 9, an image 2221 is obtained as a final print result. In this case, the image 2219 is printed first on the print medium, and the image 2220 is printed afterwards. Therefore, the image quality improvement liquid for gloss control, which has been applied during printing of the image 2219, is also present under the image quality improvement liquid for decorative printing that appears as “ABC” in the image 2221.

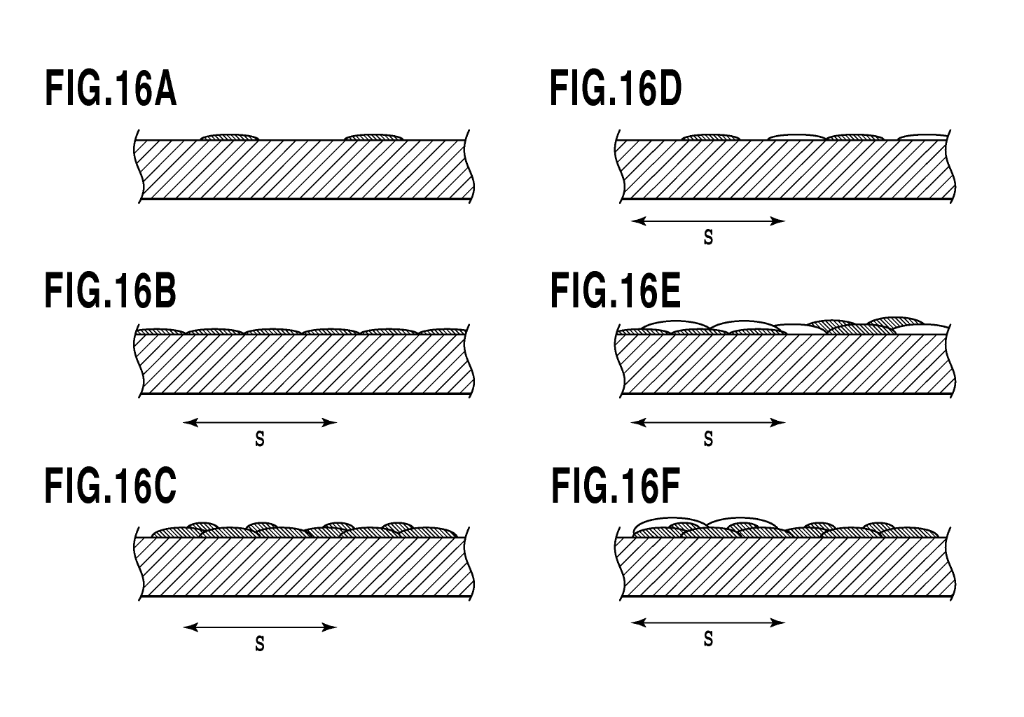

Next, while referring to FIGS. 16A to 16F, an explanation will be given for the processing for forming dots of the image quality improvement liquid on the print medium in order to obtain the decorative effects.

As well as FIGS. 2A to 2C employed for explaining the above described [Relationship between dot formation state and gloss/image clarity], FIGS. 16A to 16C are diagrams showing the state wherein dots of only color ink are formed on the print medium in accordance with a dot density. Further, FIGS. 16D to 16F are diagrams showing the state wherein the image quality improvement liquid for gloss control and the image quality improvement liquid for decorative printing are applied in the dot formation states shown in FIGS. 16A to 16C. A range S shown in FIGS. 16D to 16F indicates a portion where dots for the image quality improvement liquid for decorative printing are to be formed, and a region other than the range S indicates a portion where dots for the image quality improvement liquid for decorative printing are not to be formed.

Furthermore, for the highlight portion in FIG. 16D, the image quality improvement liquid is already applied to the region where decorative printing is not required (the region other than the range S in FIG. 16D) in order to obtain uniform gloss. Therefore, in a case wherein the image quality improvement liquid is applied further to the region for the decorative printing (the range S in FIG. 16D), control for gloss uniform would not be performed, and on the contrary, the surface would become irregular. For this reason, the image quality improvement liquid is not applied for the region in the highlight portion where decorative printing is performed.

Moreover, for the halftone portion in FIG. 16B and the shadow portion in FIG. 16C, dots of the image quality improvement liquid for decorative printing are formed on the color ink dots in the region where decorative printing is performed (the range S in FIGS. 16B and 16C). The resultant states are shown in FIGS. 16E and 16F, respectively.

When these dot formation states are provided, a difference in gloss can be obtained without changing much the condition of the surface of the printed matter. That is, since the glossiness differs between the area that is glossy due to the material of the color ink and a less glossy area that is covered with the image quality improvement liquid, desired decorative printing effects can be obtained.

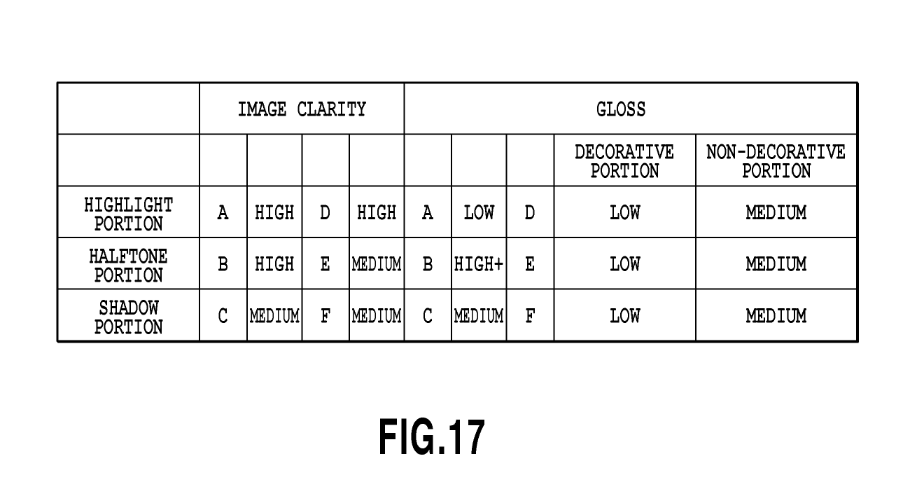

A relationship between the gloss and the image clarity for the dot formation states in FIGS. 16A to 16F is shown in FIG. 17. Reference sings A to F in FIG. 17 correspond to conditions shown in FIG. 16A to FIG. 16F respectively. As shown in FIG. 17, gloss in the decorative portion is reduced, while gloss in the non-decorative portion is high (about intermediate). Since portions having different gloss levels are formed in a printed matter and are visually identified by a person, optical decorative effects that differ from the effects obtained from a difference in hues can be provided.

Next, an explanation will be given for a technique for employing or developing the above described effects for decorative printing in order to improve the reproduction of the texture of a painting on canvas.

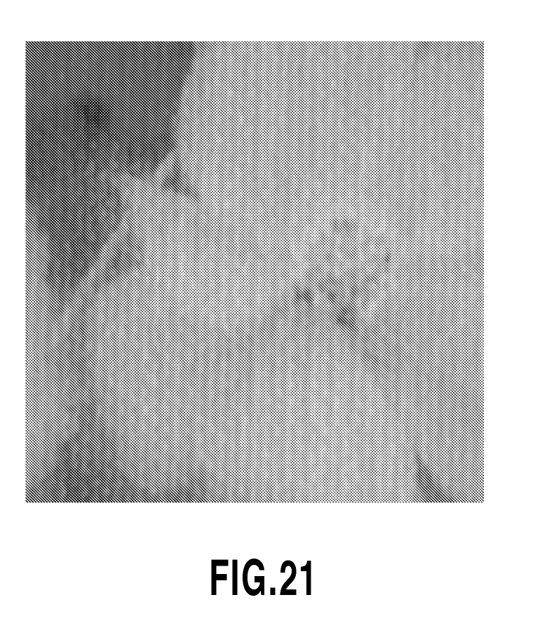

An example image obtained by photographing a painting on canvas is shown in FIG. 21. As shown in FIG. 21, a pattern of surface unevenness unique to canvas is present as a brightness pattern on the entire background where a picture pattern in a comparatively enlarged size is drawn. For the canvas, the gloss of the raised portions is high because these portions are comparatively flat, while the gloss of the recessed portions is low because there is smaller unevenness in the recessed portions. Therefore, the decorative printing technique described above is employed for this embodiment, and the recessed portions are employed as decorative portions, while the raised portions are employed as non-decorative portions, and the image quality improvement liquid is applied for the decorative portions, while the image quality improvement liquid is not applied for the non-decorative portions, so that reproduction of the surface texture of the canvas is improved. The control processing for applying the image quality improvement liquid in accordance with the raised and recessed portions of canvas will be described more in detail.

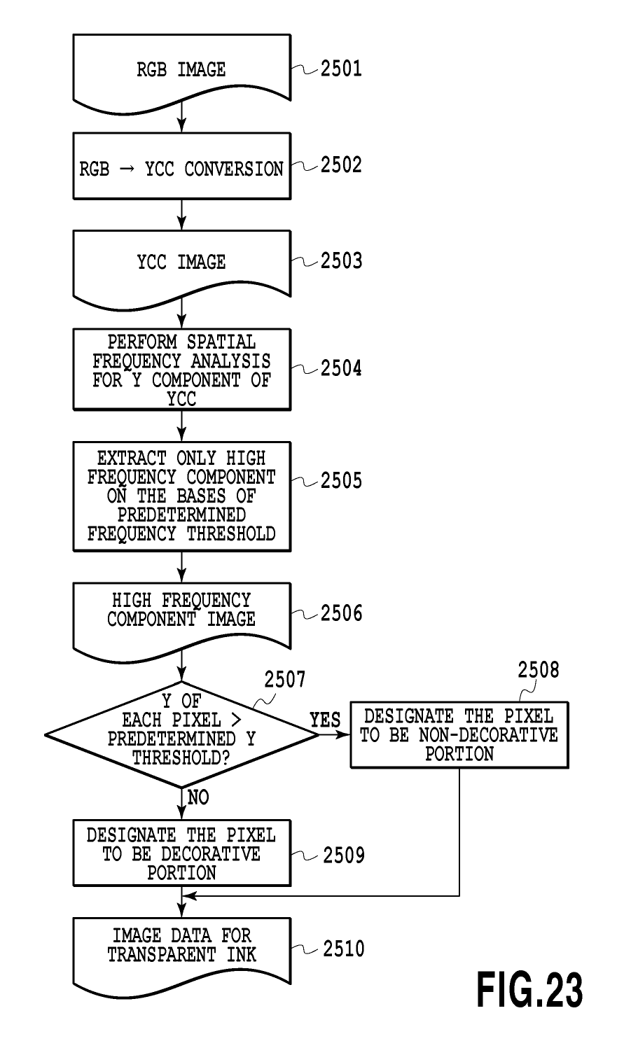

FIG. 23 is a flowchart showing a determination method for determining the recessed portions or raised portions of canvas, and the control processing based on the flowchart is performed by the host apparatus 101 in FIG. 7. The control is performed by, for example, a CPU of the host apparatus 101 according to a program.

First, data 2501 that represent RGB values of all the pixels, which form an image obtained by photographing a painting on canvas, are converted into data that represent the values of individual YCbCr components (component values) (step 2502).

The conversion of RGB into YCbCr is represented by the following expression.

TABLE 1

Y = 0.299R + 0.587G + 0.114B
Cb = 0.564(B − Y)
Cr = 0.713(R − Y)

Here, Y is a value representing brightness, Cb is a value representing saturation of blue, and Cr is a value representing saturation of red.

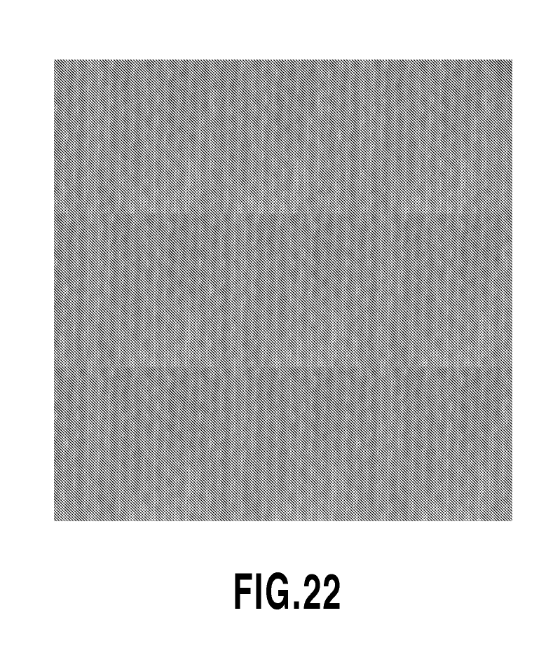

Subsequently, spatial frequency analysis is performed for the Y component of the image data 2503 that are YCbCr data obtained by conversion of the values of all the pixels (pixel values) (step 2504). Thereafter, at step 2505, only the high frequency component higher than a predetermined threshold frequency is extracted from the Y component. That is, the image 2506 that includes only the high frequency component is obtained from the brightness component Y. The obtained image 2506 is, for example, an image shown in FIG. 22. Since only the high frequency component of the brightness component Y is extracted for the image 2506, the picture pattern of a comparatively large size almost disappears, and only the pattern of the canvas remains.

At step 2507, a check is performed to determine whether the brightness component Y satisfies a predetermined condition, and based on the determination results, the pixels that includes the Y component are designated as decorative portions or non-decorative portions. That is, the value of the Y component of each pixel of the image 2506 is compared with a predetermined threshold value (Y threshold value), and when the value of the Y component is greater than the Y threshold value (i.e., the brightness is higher), the pertinent pixel is designated as a non-decorative portion (step 2508). When the Y component of a pixel is equal to or smaller than the Y threshold value (i.e., brightness is lower), the pertinent pixel is designated as a decorative portion (step 2509). Thereafter, the decorative portions and the non-decorative portions thus designated are employed to generate image data for the image quality improvement liquid that represent whether or not the image quality improvement liquid should be applied to the pertinent portion.

As described above, according to this embodiment, the portion where a spatial frequency is high is extracted in an image to identify the raised portions and the recessed portions on canvas, and the image quality improvement liquid is not applied to the bright portions that correspond to the raised portions, while the image quality improvement liquid is applied to the dark portions that correspond to the recessed portions in order to reduce the glossiness. As a result, the texture of the painting on canvas can be more appropriately reproduced on a printed image, and a printed image with high quality can be provided.

### Second Embodiment

A second embodiment of the present invention will now be described. In the second embodiment, the number of passes differs between the multi-pass printing performed with color ink and an image quality improvement liquid (image quality improvement material) for uniform gloss control, and the multi-pass printing performed with an image quality improvement liquid for decorative printing.

In the first embodiment, 2-pass printing is employed both for the first multi-pass printing using color ink and the image quality improvement liquid for uniform gloss control, and for the second multi-pass printing using the image quality improvement liquid for decorative printing, and printing of an image is completed by the total of four passes. However, for the 2-pass printing using color ink, the deviation of the landing position of ink (displacement of the dot formation position) might occur due to a manufacture variance of parts included in the mechanism of the main body of an ink jet printing apparatus, or due to variations of the conveying accuracy during the conveying operation. The deviation of the landing position causes a local density fluctuation, which might occur an image defect, such as a stripe-like image defect or density unevenness. The most effective means for avoiding these problems is to increase the number of passes for multi-pass printing using color ink to three or four passes. However, the increase of the number of passes causes the reduction of the printing speed. On the other hand, in the multi-pass printing using colorless and transparent ink, such as an image quality improvement liquid, the deviation of the landing position of the image quality improvement liquid is not regarded as the fluctuation of the image density that occurs in the printing using color ink. Therefore, even when the number of passes for applying the image quality improvement liquid is smaller than the number of passes for multi-pass printing using color ink, an image defect seldom occurs.

Therefore, for the second embodiment, the number of passes for the multi-pass printing using color ink and the image quality improvement liquid for uniform gloss control is designated as four passes, while the number of passes for the multi-pass printing using the image quality improvement liquid for decorative printing is designated as two passes, and the total six passes are employed for printing.

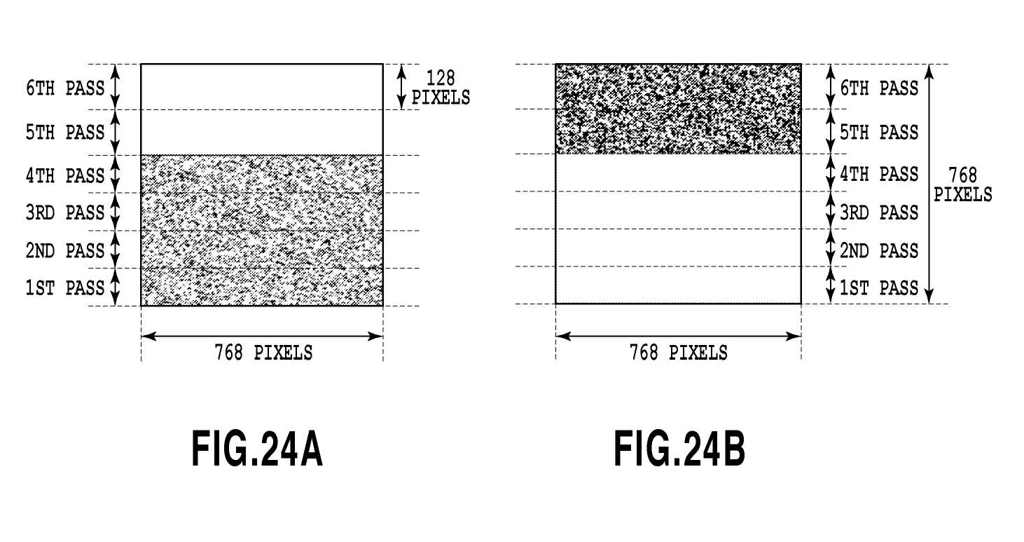

A mask pattern used for color ink printing and for uniform gloss control is shown in FIG. 24A, and a mask pattern used for decorative printing is shown in FIG. 24B. The vertical size of these mask patterns is 768 pixels that correspond to 768 nozzles prepared for a print head, and since the printing is performed along the total six passes, the individual passes are divided for every 128 pixels. This corresponds to the number of nozzles, 128.

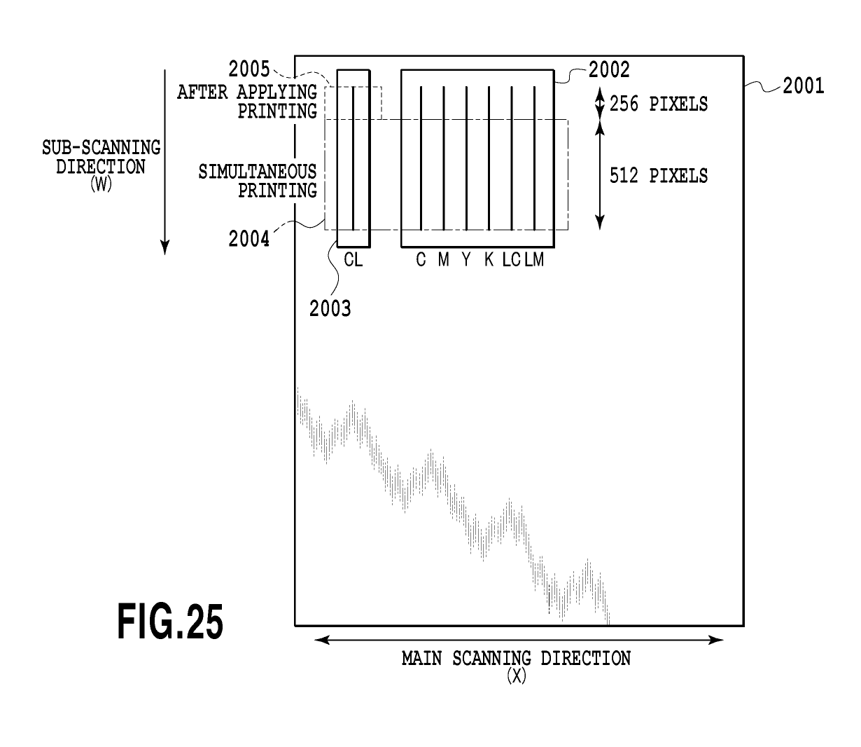

The processing for the second embodiment for applying color ink and the image quality improvement liquid will now be described while referring to FIG. 25. However, no explanation will be given for the same procedures as those in FIG. 15 for the first embodiment. In FIG. 25, an area 2004 serves as an area used by a color ink print head and also as an area used for applying the image quality improvement liquid for uniform gloss control. As described above, since this area 2004 is employed for printing with four passes, beginning from the first to the fourth pass, the printing width in the sub-scanning direction is equal to the length of 128 pixels×4=512 pixels. This number of pixels corresponds to the number of nozzles, 512.

An area 2005 is an area used by a print head for the image quality improvement liquid for the decorative printing. As described above, since this area 2005 is employed for printing with two passes, i.e., the fifth pass and the sixth pass, the printing width in the sub-scanning direction is equal to the length of 128 pixels×2=256 pixels. This number of pixels corresponds to the number of nozzles, 256. In the first embodiment, the same number of nozzles is employed for decorative printing and for controlling gloss uniformity, while in the second embodiment, the number of nozzles employed for decorative printing is greater than the number of nozzles employed for controlling gloss uniformity. Therefore, in this embodiment, the number of nozzles used for ejection of the image quality improvement liquid for uniform gloss control is equal to or greater than the number of nozzles for ejection of the image quality improvement liquid for decorative printing. Furthermore, the number of nozzles used for ejection of the image quality improvement liquid for uniform gloss control is equal to the number of nozzles for ejection of color ink.

As described above, according to the second embodiment, since the number of passes for the first multi-pass printing using color ink is increased, the fluctuation of the density caused by the deviation in the landing position of color ink, which occurs due to the variance of the mechanism of the main body of the ink jet printing apparatus, can be avoided. Furthermore, since the number of passes for the multi-pass printing using the image quality improvement liquid for decorative printing is reduced, the after applying printing function for the image quality improvement liquid for decorative printing can be provided, while the reduction of the printing speed is minimized.

### Other Embodiments

For the above described embodiments, the image quality improvement liquid (transparent ink) for gloss control has been employed for the ink jet printing apparatus. However, the present invention can also be applied for an electrophotographic printing apparatus. That is, colored toner and transparent toner are loaded in the electrophotographic printing apparatus, and as an image quality control material, the transparent toner is applied to a print medium. As a result, the same effects as obtained for a case wherein the ink jet printing apparatus is employed are acquired.

Furthermore, in the above embodiments, the RGB signal has been converted into the YCbCr signal in order to extract the brightness component of an image. However, the present invention is not limited to these embodiments, and another well known conversion method can also be employed.

Moreover, in a case wherein a reproduction is printed not only for a painting on canvas, but also for a painting on a medium having woven patterns, gloss of an image can be controlled based on a woven pattern having a high spatial frequency, so that the texture of the original painting can be reproduced. As a result, unique printing effects can be obtained.

As described above, according to the embodiments of this invention, for printing a reproduction of a painting on canvas, gloss is provided locally only on the portions that correspond to the raised portions of tiny unevenness on the canvas, and therefore, the texture of the original painting can be more appropriately reproduced.

The image processing in each embodiment may be performed by a CPU of a host PC executing a program for performing the image processing explained with respect to each embodiment, the program being stored in a non-volatile medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-010350, filed Jan. 23, 2013, which is hereby incorporated by reference herein in its entirety.

What is claimed is:

1. An image processing apparatus comprising:
a determining unit configured to determine, based on image data for an image to be printed on a print medium, amounts of a color printing material for printing the image on the print medium and an image quality control material for adjusting glossiness of the image; and
an unevenness information obtaining unit configured to obtain information on an unevenness level of a surface of the image based on the image data;
wherein the determining unit determines the amount of the image quality control material to be applied to the print medium based on the unevenness level indicated by the information obtained by the unevenness information obtaining unit.

2. An image processing apparatus according to claim 1, wherein the image data indicates values of each pixel of a digital image composed of a plurality of pixels, and the values of each pixel are three component values.

3. An image processing apparatus according to claim 2, wherein the unevenness information obtaining unit performs spatial frequency analysis for at least one component value out of the three component values or out of three other component values obtained from the three component values, and extracts an image having a frequency component in which the at least one component value is higher than a predetermined threshold frequency, thereby obtaining the information on the unevenness level.

4. An image processing apparatus according to claim 3, wherein the determining unit determines to apply the image quality control material to only a portion in which at least one component value satisfies a predetermined condition, of the image extracted by the unevenness information obtaining unit.

5. An image processing apparatus according to claim 1, wherein the image data is image pickup data obtained by photographing an image on a medium.

6. An image processing apparatus according to claim 1, further comprising a printing unit for forming the image by ejecting ink to the print medium, wherein the printing unit ejects the ink to the print medium based on the determined amounts of the printing material and the image quality control material, and
the printing material is color ink, and the image quality control material is transparent ink.

7. An image processing apparatus according to claim 1, wherein the image processing apparatus is an electrophotographic printing apparatus comprising a printing unit for applying toner to the print medium, the printing material is color toner, and the image quality control material is transparent toner.

8. An image processing apparatus according to claim 2, wherein the three component values which are the values of each pixel of the digital image indicate gradations of R (red), G (green), and B (blue).

9. An image processing apparatus according to claim 1, wherein the printing material includes at least a C (cyan) color material, an M (magenta) color material, and an Y (yellow) color material.

10. An image processing apparatus according to claim 1, wherein the printing material includes at least a K (black) color material.

11. An image processing apparatus according to claim 5, wherein the image data is image pickup data obtained by photographing a painting on a cloth.

12. An image processing method comprising:
a determining step of determining, based on image data for an image to be printed on a print medium, amounts of a color printing material for printing the image on the print medium and an image quality control material for adjusting glossiness of the image; and
an unevenness information obtaining step of obtaining information on an unevenness level of a surface of the image based on the image data;
wherein in the determining step, the amount of the image quality control material to be applied to the print medium is determined based on the unevenness level indicated by the information obtained in the unevenness information obtaining step.

13. A printed matter comprising:
a print medium; and
an image formed by a color printing material and a transparent material on the print medium;
wherein a difference in an amount of the transparent material in the image causes a cloth-like pattern to be reproduced, and a portion of the image whose amount of the transparent material is larger than that of the transparent material around the portion reproduces a recessed portion in a cloth.
